(19) United States
(12) Patent Application Publication
(10) Pub. No.: US 2010/0311592 A1
(43) Pub. Date: Dec. 9, 2010

(54) USE OF 2-IODO-N 4-METHOXY-6-METHYL-1,3,5-TRIAZINE-2-YL CARBAMOYL BENZENESULFONAMIDE AND/OR SALTS THEREOF FOR COMBATING UNDESIRED PLANT GROWTH IN SELECTED USEFUL PLANT CROPS OR NON-CULTIVATED LAND

(75) Inventors: Christian Waldraff, Bad Vilbel (DE); Erwin Hacker, Hochheim (DE); Hans Philipp Huff, Eppstein (DE); Martin Jeffrey Hills, Idstein (DE); Dieter Feucht, Eschborn (DE); Dominique Schreiber, Frankfurt (DE); Klaus-Helmut Mueller, Duesseldorf (DE); Ernst Rudolf Gesing, Erkrath-Hochdahl (DE); Hansjoerg Kraehmer, Hofheim (DE); Georg Bonfig-Picard, Rodenbach (DE); Martin Hess, Mainz (DE)

Correspondence Address: Baker Donelson Bearman, Caldwell & Berkowitz, PC, 920 Massachusetts Ave, NW, Suite 900, Washington, DC, 20001, US

(73) Assignee: Bayer CropScience AG, Monheim (DE)

(21) Appl. No.: 12/738,401

(22) PCT Filed: Oct. 22, 2008
(86) PCT No.: PCT/EP2008/008945

§ 371 Date: Aug. 23, 2010

(30) Foreign Application Priority Data
Oct. 24, 2007 (EP) 07020806.1

(51) Int. Cl. A01N 47/36; A01P 13/02

(52) U.S. Cl. 504/213; 504/212

(57) ABSTRACT

The invention relates to the use of 2-iodo-N-[(4-methoxy-6-methyl-1,3,5-triazin-2-yl)carbamoyl]benzenesulfonamide and/or its salts for the selective control of unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops.

The invention relates to the use of 2-iodo-N-[(4-methoxy-6-methyl-1,3,5-triazin-2-yl)carbamoyl]benzenesulfonamide and/or its salts for the selective control of unwanted harmful plants in crops of useful plants, permanent crops or on non-crop land, and also as plant growth regulators, on their own or with safeners and/or in combination with other herbicides, to their use for controlling unwanted harmful plants (such as, for example, broad-leaved weeds/weed grasses) in specific crop plants or as crop protection regulators, for simultaneous and/or sequential application, either as a readymix or as a tank mix.

It is known that certain sulfonylureas, such as, for example, chlorsulfuron and metsulfuron-methyl, have herbicidal properties (cf. DE 27 15 786). From WO 2006/114220, it is furthermore known that sulfonamides iodinated at the phenyl ring have herbicidal properties. However, the herbicidal activity of these known compounds is not satisfactory in all respects such as, for example, compatibility, activity spectrum, speed of action, behavior in the environment, in the soil and toward non-target plants/follower crops (R. J. Hance, K. Holly, Weed Control Handbook, 8th edition, Blackwell 1990) or application flexibility.

It is an object of the present invention to provide better control of unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops.

Surprisingly, it has been found that this object can be achieved by using 2-iodo-N-[(4-methoxy-6-methyl-1,3,5-triazin-2-yl)carbamoyl]benzenesulfonamide and/or its salts, if appropriate in combination with safeners which, with respect to the crop plant in question, provide sufficient compatibility which is not given, or is not given to a sufficient degree, when 2-iodo-N-[(4-methoxy-6-methyl-1,3,5-triazin-2-yl)carbamoyl]benzenesulfonamide and/or its salts is/are used on its/their own.

Accordingly, the present invention relates to the use of 2-iodo-N-[(4-methoxy-6-methyl-1,3,5-triazin-2-yl)carbamoyl]benzenesulfonamide and/or its salts for the selective control of unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops.

2-Iodo-N-[(4-methoxy-6-methyl-1,3,5-triazin-2-yl)carbamoyl]benzenesulfonamide is known, as is its preparation, for example from DE 27 15 786 C2, which is hereby incorporated into the present description.

The invention furthermore relates to the use of salts of 2-iodo-N-[(4-methoxy-6-methyl-1,3,5-triazin-2-yl)carbamoyl]benzenesulfonamide which are obtained from 2-iodo-N-[(4-methoxy-6-methyl-1,3,5-triazin-2-yl)carbamoyl]benzenesulfonamide by customary processes. The preparation of such salts is known from the prior art, cf. also in this regard the European patent application EP 07020807.9, filed on Oct. 24, 2007, from Bayer CropScience AG entitled: “Salze des 2-Iodo-N-[(4-methoxy-6-methyl-1,3,5-triazin-2-yl)carbamoyl]benzolsulfonamid, Verfahren zu deren Herstellung, sowie deren Verwendung als Herbizide und Pflanzenwachstumsregulatoren” [Salts of 2-iodo-N-[(4-methoxy-6-methyl-1,3,5-triazin-2-yl)carbamoyl]benzenesulfonamide, processes for their preparation and their use as herbicides and plant growth regulators].

The present invention preferably provides the use of 2-iodo-N-[(4-methoxy-6-methyl-1,3,5-triazin-2-yl)carbamoyl]benzenesulfonamide and of compounds of the formula (I)

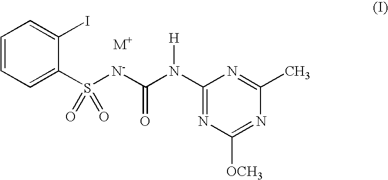

where
the cation (M⁺) (a) is an alkali metal ion, preferably a lithium, sodium or potassium ion or
   (b) is an alkaline earth metal ion, preferably a calcium or magnesium ion, or
   (c) is a transition metal ion, preferably a manganese, copper, zinc or iron ion, or
   (d) is an ammonium ion in which optionally one, two, three or all four hydrogen atoms are substituted by identical or different radicals from the group consisting of (C₁-C₄)-alkyl, hydroxy-(C₁-C₄)-alkyl, (C₃-C₆)-cycloalkyl, (C₁-C₄)-alkoxy-(C₁-C₄)-alkyl, hydroxy-(C₁-C₄)-alkoxy-(C₁-C₄)-alkyl, (C₁-C₆)-mercaptoalkyl, phenyl and benzyl, where the radicals mentioned above are optionally substituted by one or more identical or different radicals from the group consisting of halogen, such as F, Cl, Br
   or I, nitro, cyano, azido, (C₁-C₆)-alkyl, (C₁-C₆)-haloalkyl, (C₃-C₆)-cycloalkyl, (C₁-C₆)-alkoxy, (C₁-C₆)-haloalkoxy and phenyl, and where in each case two substituents at the nitrogen atom together optionally form an unsubstituted or substituted ring, or
   (e) is a phosphonium ion, or
   (f) is a sulfonium ion, preferably tri-((C₁-C₄)-alkyl)sulfonium, or
   (g) is an oxonium ion, preferably tri-((C₁-C₄)-alkyl)oxonium, or
   (h) is a saturated or unsaturated/aromatic nitrogenous heterocyclic ionic compound which has 1-10 carbon atoms in the ring system and is optionally mono- or polycondensed and/or mono- or polysubstituted by (C₁-C₄)-alkyl
      for the selective control of unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops.

Preference is furthermore given to the use of 2-iodo-N-[(4-methoxy-6-methyl-1,3,5-triazin-2-yl)carbamoyl]benzenesulfonamide and of compounds of the formula (I) in which the cation (M+)
(a) is an alkali metal ion, preferably a lithium, sodium or potassium ion or
(b) is an alkaline earth metal ion, preferably a calcium or magnesium ion, or
(c) is a transition metal ion, preferably a manganese, copper, zinc or iron ion, or
(d) is an ammonium ion in which optionally one, two, three or all four hydrogen atoms are substituted by identical or different radicals from the group consisting of (C₁-C₄)-alkyl, hydroxy-(C₁-C₄)-alkyl, (C₃-C₄)-cycloalkyl, (C₁-C₂)-alkoxy-(C₁-C₂)-alkyl, hydroxy-(C₁-C₂)-alkoxy-(C₁-C₂)-alkyl, (C₁-C₆)-mercaptoalkyl, phenyl and benzyl, where the radicals mentioned above are optionally substituted by one or more identical or different radicals from the group consisting of halogen, such as F, Cl, Br
or I, nitro, cyano, azido, (C₁-C₂)-alkyl, (C₁-C₂)-haloalkyl, (C₃-C₄)-cycloalkyl, (C₁-C₂)-alkoxy, (C₁-C₂)-haloalkoxy and phenyl, and where in each case two substituents at the nitrogen atom together optionally form an unsubstituted or substituted ring, or
(e) is a quaternary phosphonium ion, preferably tetra-((C₁-C₄)-alkyl)phosphonium or tetraphenylphosphonium, where the (C₁-C₄)-alkyl radicals and the phenyl radicals are optionally mono- or polysubstituted by identical or different radicals from the group consisting of halogen, such as F, Cl, Br or I, (C₁-C₂)-alkyl, (C₁-C₂)-haloalkyl, (C₃-C₄)-cycloalkyl, (C₁-C₂)-alkoxy and (C₁-C₂)-haloalkoxy, or
(f) is a tertiary sulfonium ion, preferably tri-((C₁-C₄)-alkyl)sulfonium or triphenylsulfonium, where the (C₁-C₄)-alkyl radicals and the phenyl radicals are optionally mono- or polysubstituted by identical or different radicals from the group consisting of halogen, such as F, Cl, Br or I, (C₁-C₂)-alkyl, (C₁-C₂)-haloalkyl, (C₃-C₄)-cycloalkyl, (C₁-C₂)-alkoxy and (C₁-C₂)-haloalkoxy, or
(g) is a tertiary oxonium ion, preferably tri-((C₁-C₄)-alkyl)oxonium, where the (C₁-C₄)-alkyl radicals are optionally mono- or polysubstituted by identical or different radicals from the group consisting of halogen, such as F, Cl, Br or I, (C₁-C₂)-alkyl, (C₁-C₂)-haloalkyl, (C₃-C₄)-cycloalkyl, (C₁-C₂)-alkoxy and (C₁-C₂)-haloalkoxy, or
(h) is a cation from the group consisting of the following heterocyclic compounds, such as, for example, pyridine, quinoline, 2-methylpyridine, 3-methylpyridine, 4-methylpyridine, 2,4-dimethylpyridine, 2,5-dimethylpyridine, 2,6-dimethylpyridine, 5-ethyl-2-methylpyridine, piperidine, pyrrolidine, morpholine, thiomorpholine, pyrrole, imidazole, 1,5-diazabicyclo[4.3.0]non-5-ene (DBN) and 1,8-diazabicyclo[5.4.0]undec-7-ene (DBU)
   for the selective control of unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops.

Active compounds which are preferred according to the invention for the selective control of unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops are 2-iodo-N-[(4-methoxy-6-methyl-1,3,5-triazin-2-yl)carbamoyl]benzenesulfonamide and also the compounds of the formula (I) listed in Table 1 below

TABLE 1
Compounds of the formula (I), where M⁺ denotes the
the respective salt of the compound
(I)

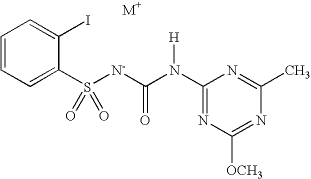

| Compound | M+ |
|---|---|
| I-1 | lithium |
| I-2 | sodium |
| I-3 | potassium |
| I-4 | magnesium |
| I-5 | calcium |
| I-6 | ammonium |
| I-7 | methylammonium |
| I-8 | dimethylammonium |
| I-9 | tetramethylammonium |
| I-10 | ethylammonium |
| I-11 | diethylammonium |
| I-12 | tetraethylammonium |
| I-13 | propylammonium |
| I-14 | tetrapropylammonium |
| I-15 | isopropylammonium |
| I-16 | diisopropylammonium |
| I-17 | butylammonium |
| I-18 | tetrabutylammonium |
| I-19 | (2-hydroxyeth-1-yl)ammonium |
| I-20 | bis-N,N-(2-hydroxyeth-1-yl)ammonium |
| I-21 | tris-N,N,N-(2-hydroxyeth-1-yl)ammonium |
| I-22 | 1-phenylethylammonium |
| I-23 | 2-phenylethylammonium |
| I-24 | trimethylsulfonium |
| I-25 | trimethyloxonium |
| I-26 | pyridinium |
| I-27 | 2-methylpyridinium |
| I-28 | 4-methylpyridinium |
| I-29 | 2,4-dimethylpyridinium |
| I-30 | 2,6-dimethylpyridinium |
| I-31 | piperidinium |
| I-32 | imidazolium |
| I-33 | morpholinium |
| I-34 | 1,5-diazabicyclo[4.3.0]non-7-enium |
| I-35 | 1,8-diazabicyclo[5.4.0]undec-7-enium |

Preference is furthermore given to the use of 2-iodo-N-[(4-methoxy-6-methyl-1,3,5-triazin-2-yl)carbamoyl]benzenesulfonamide and of compounds of the formula (I) in which the cation (M+)

is a sodium ion, a potassium ion, a lithium ion, a magnesium ion, a calcium ion, an NH₄⁺ ion, a (2-hydroxyeth-1-yl)ammonium ion, a bis-N,N-(2-hydroxyeth-1-yl)ammonium ion, a tris-N,N,N-(2-hydroxyeth-1-yl)ammonium ion, a methylammonium ion, a dimethylammonium ion, a trimethylammonium ion, a tetramethylammonium ion, an ethylammonium ion, a diethylammonium ion, a triethylammonium ion, a tetraethylammonium ion, an isopropylammonium ion, a diisopropylammonium ion, a tetrapropylammonium ion, a tetrabutylammonium ion, a 2-(2-hydroxyeth-1-oxy)eth-1-ylammonium ion, a di-(2-hydroxyeth-1-yl)ammonium ion, a trimethylbenzylammonium ion, a tri-((C₁-C₄)-alkyl)sulfonium ion or a tri-((C₁-C₄)-alkyl)oxonium ion, a benzylammonium ion, a 1-phenylethylammonium ion, a 2-phenylethylammonium ion, a diisopropylethylammonium ion, a pyridinium ion, a piperidinium ion, an imidazolium ion, a morpholinium ion, a 1,8-diazabicyclo[5.4.0]undec-7-enium ion
for the selective control of unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops.

Preference is furthermore given to the use of 2-iodo-N-[(4-methoxy-6-methyl-1,3,5-triazin-2-yl)carbamoyl]benzenesulfonamide and of compounds of the formula (I) in which the cation (M⁺) is a sodium ion, a potassium ion, a magnesium ion, a calcium ion or an NH₄⁺ ion for the selective control of unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops.

Particular preference is given to the use of 2-iodo-N-[(4-methoxy-6-methyl-1,3,5-triazin-2-yl)carbamoyl]benzenesulfonamide and of compounds of the formula (I) in which the cation (M⁺) is a sodium ion, a potassium ion or an NH₄⁺ ion for the selective control of unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops.

Very particular preference is given to the use of 2-iodo-N-[(4-methoxy-6-methyl-1,3,5-triazin-2-yl)carbamoyl]benzenesulfonamide and of compounds of the formula (I) in which the cation (M⁺) is a sodium ion or a potassium ion for the selective control of unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops.

From among the crop species mentioned above, use in the crops barley, oats and rye is preferred, use in wheat, barley and oats is particularly preferred and use in wheat and barley is very particularly preferred.

The abovementioned salts of 2-iodo-N-[(4-methoxy-6-methyl-1,3,5-triazin-2-yl)carbamoyl]benzenesulfonamide are obtained in a simple manner by customary methods for forming salts, for example by dissolving or dispersing 2-iodo-N-[(4-methoxy-6-methyl-1,3,5-triazin-2-yl)carbamoyl]benzenesulfonamide in a suitable diluent, such as, for example, methylene chloride, acetone, tert-butyl methyl ether or toluene, and by adding a suitable base. The salts can then—if required after prolonged stirring—be isolated by concentration or filtration with suction. Further and more detailed statements on the salt formation of 2-iodo-N-[(4-methoxy-6-methyl-1,3,5-triazin-2-yl)carbamoyl]benzenesulfonamide can be found in the application, filed on the same date at the European Patent Office, from Bayer CropScience AG entitled: “Salze des 2-Iodo-N-[(4-methoxy-6-methyl-1,3,5-triazin-2-yl)carbamoyl]benzolsulfonamid, Verfahren zu deren Herstellung, sowie deren Verwendung als Herbizide and Pflanzenwachstumsregulatoren” [Salts of 2-iodo-N-[(4-methoxy-6-methyl-1,3,5-triazin-2-yl)carbamoyl]benzenesulfonamide, processes for their preparation and their use as herbizides and plant growth regulators].

In formula (I), the carbon-containing radicals, such as alkyl, alkoxy, may in each case be straight-chain or branched, for example methyl, ethyl, n- or i-propyl, n-, i-, t- or 2-butyl.

Cycloalkyl denotes a carbocyclic saturated ring system having preferably 3-6 carbon atoms, for example cyclopropyl, cyclobutyl, cyclopentyl or cyclohexyl.

Depending on the nature and the attachment of the substituents, the compounds of the formula (I) may be present as stereoisomers. The formula (I) encompasses all possible stereoisomers defined by their specific spatial form, such as enantiomers, diastereomers, Z and E isomers.

If, for example, one or more alkenyl groups are present, diastereomers (Z and E isomers) may occur. If, for example, one or more asymmetric carbon atoms are present, enantiomers and diastereomers may occur. Stereoisomers may be obtained from the mixtures resulting from the preparation using customary separation methods, for example by chromatographic separation techniques. It is also possible to prepare stereoisomers selectively by using stereoselective reactions employing optically active starting materials and/or auxiliaries. Accordingly, the invention also relates to all stereoisomers embraced by the formula (I) but not shown in their specific stereoform, and to their mixtures.

2-Iodo-N-[(4-methoxy-6-methyl-1,3,5-triazin-2-yl)carbamoyl]benzenesulfonamide and its salts, preferably its salts according to the compounds of the formula (I), can be used for controlling unwanted vegetation. Unwanted plants are to be understood as meaning all plants which grow in locations where they are unwanted. These can be, for example, harmful plants (for example weeds or unwanted crop plants), including, for example, those resistant to certain herbicidally active compounds such as glyphosate, atrazine, glufosinate or imidazolinone herbicides. 2-Iodo-N-[(4-methoxy-6-methyl-1,3,5-triazin-2-yl)carbamoyl]benzenesulfonamides the compounds of the formula (I) can be used, for example, against the following plants:

Monocotyledonous weeds, for example of the genera Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Ischaemum, Sphenoclea, Dactyloctenium, Agrostis, Alopecurus, Apera.

Dicotyledonous weeds, for example of the genera Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum, Euphorbia and Fallopia.

By virtue of their herbicidal and plant growth-regulatory properties, 2-iodo-N-[(4-methoxy-6-methyl-1,3,5-triazin-2-yl)carbamoyl]benzenesulfonamide and/or its salts, in particular compounds of the formula (I), are also suitable for controlling harmful plants in crops of known and yet to be developed genetically modified plants (hereinbelow synonymously also referred to as “transgenic plants”) (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns. In general, the transgenic plants are distinguished by especially advantageous properties, for example by resistances/tolerances to certain pesticides, mainly certain herbicides, resistances to plant diseases or causative organisms of plant diseases, such as certain insects or microorganisms such as fungi, bacteria or viruses. Other specific characteristics relate, for example, to the harvested material with regard to quantity, quality, storability, composition and content of specific constituents. Thus, transgenic plants are known whose starch content is increased, or whose starch quality is altered, or those where the harvested material has a different fatty acid composition.

Likewise, 2-iodo-N-[(4-methoxy-6-methyl-1,3,5-triazin-2-yl)carbamoyl]benzenesulfonamide and/or its salts, in particular compounds of the formula (I), by virtue of their herbicidal and plant growth-regulatory properties, can also be used for controlling harmful plants in crops of known and yet to be developed plants obtained by mutant selection (hereinbelow synonymously also referred to as “mutagenic plants” or “mutagenic crops”).

Preference is given to the use of 2-iodo-N-[(4-methoxy-6-methyl-1,3,5-triazin-2-yl)carbamoyl]benzenesulfonamide and/or its salts, in particular of compounds of the formula (I), in economically important transgenic crops or crops obtained by mutant selection (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns.

Preference is given to the use of 2-iodo-N-[(4-methoxy-6-methyl-1,3,5-triazin-2-yl)carbamoyl]benzenesulfonamide and/or its salts, in particular of compounds of the formula (I), as herbicides (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns which are resistant or have been made resistant by genetic engineering to the phytotoxic effects of herbicides, or have been obtained by mutant selection. The salts according to the invention, in particular the compounds of the formula (I), may likewise preferably be used as herbicides in the above-mentioned crops of useful plants which are a crossbreed of plants which have been made resistant by genetic engineering and plants which have been obtained by mutant selection, as described, for example, in WO 2007/024782.

Generally known ways of preparing novel plants and cultivars which have modified properties compared to known plants comprise, for example, traditional breeding methods—such as hybridization or selection breeding—and the generation of mutants.

Likewise, novel plants with altered properties can be generated with the aid of recombinant methods (see, for example, EP-A-0221044, EP-A-0131624). For example, the following have been described in several cases:
recombinant modifications of crop plants for the purposes of modifying the starch synthesized in the plants (for example WO 92/11376, WO 92/14827, WO 91/19806),
transgenic crop plants which are resistant to certain herbicides of the glufosinate type (cf., for example, EP-A-0242236, EP-A-242246) or the glyphosate type (WO 92/00377) or the sulfonylurea type (EP-A-0257993, U.S. Pat. No. 5,013,659),
transgenic crop plants, for example cotton, which is capable of producing Bacillus thuringiensis toxins (Bt toxins), which make the plants resistant to certain pests (EP-A-0142924, EP-A-0193259),
transgenic crop plants with a modified fatty acid composition (WO 91/13972).

A large number of techniques in molecular biology are known in principle with the aid of which novel transgenic plants with modified properties can be generated; see, for example, Sambrook et al., 1989, Molecular Cloning, A Laboratory Manual, 2^{nd} Edition, Cold Spring Harbor Laboratory Press, Cold Spring Harbor, N.Y.; or Winnacker “Gene und Klone”, VCH Weinheim 2^{nd} Edition 1996 or Christou, “Trends in Plant Science” 1 (1996) 423-431).

To carry out such recombinant manipulations, nucleic acid molecules which allow mutagenesis or sequence changes by recombination of DNA sequences can be introduced into plasmids. For example, base substitutions can be carried out, part-sequences can be removed, or natural or synthetic sequences can be added with the aid of the standard methods mentioned above. To connect the DNA fragments to each other, adapters or linkers may be added to the fragments.

For example, the generation of plant cells with a reduced activity of a gene product can be achieved by expressing at least one corresponding antisense RNA, a sense RNA for achieving a cosuppression effect or by expressing at least one suitably constructed ribozyme which specifically cleaves transcripts of the above-mentioned gene product.

To this end, it is possible to use DNA molecules which encompass the entire coding sequence of a gene product inclusive of any flanking sequences which may be present, and also DNA molecules which only encompass portions of the coding sequence, it being necessary for these portions to be long enough to have an antisense effect in the cells. The use of DNA sequences which have a high degree of homology to the coding sequences of a gene product, but are not completely identical to them, is also possible.

When expressing nucleic acid molecules in plants, the protein synthesized can be localized in any desired compartment of the plant cell. However, to achieve localization in a particular compartment, it is possible, for example, to link the coding region with DNA sequences which ensure localization in a particular compartment. Such sequences are known to the person skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106).

The transgenic plant cells can be regenerated by known techniques to give rise to entire plants. In principle, the transgenic plants can be plants of any desired plant species, i.e. not only monocotyledonous, but also dicotyledonous plants.

Thus, transgenic plants can be obtained whose properties are altered by overexpression, suppression or inhibition of homologous (=natural) genes or gene sequences or the expression of heterologous (=foreign) genes or gene sequences.

Preferably, 2-iodo-N-[(4-methoxy-6-methyl-1,3,5-triazin-2-yl)carbamoyl]benzenesulfonamide and/or its salts, in particular compounds of the formula (I), can be used in transgenic crops or crops obtained by mutant selection or crossbreeds thereof which are resistant, for example, to herbicides from the group consisting of the sulfonylureas, glufosinate-ammonium or glyphosate-isopropylammonium and analogous active compounds.

When using 2-iodo-N-[(4-methoxy-6-methyl-1,3,5-triazin-2-yl)carbamoyl]benzenesulfonamide and/or its salts, in particular compounds of the formula (I), in transgenic crops or crops obtained by mutant selection or crossbreeds thereof, in addition to the effects against harmful plants which can be observed in other crops, there are frequently effects which are specific to the application in the respective transgenic crops or crops obtained by mutant selection or crossbreeds thereof, for example a modified or specifically broadened spectrum of weeds which can be controlled, modified application rates which can be used for the application, preferably good combinability with the herbicides to which the transgenic crop is resistant, and an effect on the growth and the yield of the transgenic crop plants, and also in the cultivation of these crops following application of the substances according to the invention.

The invention therefore also provides for the use of 2-iodo-N-[(4-methoxy-6-methyl-1,3,5-triazin-2-yl)carbamoyl]benzenesulfonamide and/or its salts, in particular of compounds of the formula (I), as herbicides for controlling harmful plants in the abovementioned transgenic crop plants and/or the abovementioned crop plants obtained by mutation selection or crossbreeds thereof.

2-Iodo-N-[(4-methoxy-6-methyl-1,3,5-triazin-2-yl)carbamoyl]benzenesulfonamide and its salts, preferably its salts according to the compounds of the formula (I), have, for example, excellent selectivity in crops of barley. They are thus suitable, for example, for the selective control of unwanted vegetation, for example of harmful plants (for example monocotyledonous and dicotyledonous weeds or unwanted crop plants), in barley, for example by the pre-sowing method, the pre-emergence method or the post-emergence method.

Suitable barley plants are, for example, transgenic and non-transgenic plants or plants obtained by mutant selection or crossbreeds of the plants mentioned above. By way of example, barley cultivars such as Belana, Pasadena, Sebastian and Tocada may be mentioned here.

2-Iodo-N-[(4-methoxy-6-methyl-1,3,5-triazin-2-yl)carbamoyl]benzenesulfonamide and its salts, preferably its salts according to the compounds of the formula (I), can be converted into customary formulations such as solutions, emulsions, suspensions, powders, foams, pastes, granules, aerosoles, natural and synthetic materials impregnated with active compound and microencapsulations in polymeric materials. The formulations may comprise the customary auxiliaries and additives.

These formulations are produced in a known manner, for example by mixing 2-iodo-N-[(4-methoxy-6-methyl-1,3,5-triazin-2-yl)carbamoyl]benzenesulfonamide and/or its salts, in particular compounds of the formula (I), with extenders, that is, liquid solvents, liquefied gases under pressure, and/or solid carriers, optionally with the use of surfactants, that is emulsifiers and/or dispersants and/or foam formers.

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulfoxide, and also water.

Suitable solid carriers are: for example ammonium salts and ground natural minerals such as kaolins, clays, talc, chalk, quartz, attapulgite, montmorillonite or diatomaceous earth, and ground synthetic minerals such as highly-disperse silica, alumina and silicates; suitable solid carriers for granules are: for example crushed and fractionated natural rocks, such as calcite, marble, pumice, sepiolite and dolomite, and also synthetic granules of inorganic and organic meals, and granules of organic material, such as sawdust, coconut shells, corn cobs and tobacco stalks; suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkyl sulfonates, alkyl sulfates, aryl sulfonates, and also protein hydrolysates; suitable dispersants are: for example lignosulfite waste liquors and methyl cellulose.

Tackifiers, such as carboxymethyl cellulose, natural and synthetic polymers in the form of powders, granules or latices, such as gum arabic, polyvinyl alcohol and polyvinyl acetate, and also natural phospholipids, such as cephalins and lecithins, and synthetic phospholipids can be used in the formulations. Other possible additives are mineral and vegetable oils.

The herbicidal activity of 2-iodo-N-[(4-methoxy-6-methyl-1,3,5-triazin-2-yl)carbamoyl]benzenesulfonamide and/or its salts, in particular compounds of the formula (I), can likewise be improved, for example, by surfactants, preferably by wetting agents from the group of the fatty alcohol polyglycol ethers. The fatty alcohol polyglycol ethers preferably comprise 10-18 carbon atoms in the fatty alcohol radical and 2-20 ethylene oxide units in the polyglycol ether moiety. The fatty alcohol polyglycol ethers may be present in nonionic form, or ionic form, for example in the form of fatty alcohol polyglycol ether sulfates, which may be used, for example, as alkali metal salts (for example sodium salts and potassium salts) or ammonium salts, or even as alkaline earth metal salts, such as magnesium salts, such as C₁₂/C₁₄-fatty alcohol diglycol ether sulfate sodium (Genapol® LRO, Clariant GmbH); see, for example, EP-A-0476555, EP-A-0048436, EP-A-0336151 or U.S. Pat. No. 4,400,196 and also Proc. EWRS Symp. “Factors Affecting Herbicidal Activity and Selectivity”, 227-232 (1988). Nonionic fatty alcohol polyglycol ethers are, for example, (C₁₀-C₁₈)-, preferably (C₁₀-C₁₄)-fatty alcohol polyglycol ethers (for example isotridecyl alcohol polyglycol ethers) which comprise 2-20, preferably 3-15, ethylene oxide units, for example those from the Genapol® X series, such as Genapol® X-030, Genapol® X-060, Genapol® X-080 or Genapol® X-150 (all from Clariant GmbH).

The present invention further comprises the combination of 2-iodo-N-[(4-methoxy-6-methyl-1,3,5-triazin-2-yl)carbamoyl]benzenesulfonamide and/or its salts, in particular compounds of the formula (I), with the wetting agents mentioned above from the group of the fatty alcohol polyglycol ethers which preferably contain 10-18 carbon atoms in the fatty alcohol radical and 2-20 ethylene oxide units in the polyglycol ether moiety and which may be present in nonionic or ionic form (for example as fatty alcohol polyglycol ether sulfates). Preference is given to C₁₂/C₁₄-fatty alcohol diglycol ether sulfate sodium (Genapol® LRO, Clariant GmbH) and isotridecyl alcohol polyglycol ether having 3-15 ethylene oxide units, for example from the Genapol® X series, such as Genapol® X-030, Genapol® X-060, Genapol® X-080 and Genapol® X-150 (all from Clariant GmbH). Furthermore, it is known that fatty alcohol polyglycol ethers, such as nonionic or ionic fatty alcohol polyglycol ethers (for example fatty alcohol polyglycol ether sulfates) are also suitable for use as penetrants and activity enhancers for a number of other herbicides (see, for example, EP-A-0502014).

Furthermore, it is known that fatty alcohol polyglycol ethers, such as nonionic or ionic fatty alcohol polyglycol ethers (for example fatty alcohol polyglycol ether sulfates) are also suitable for use as penetrants and activity enhancers for a number of other herbicides (see, for example, EP-A-0502014).

The herbicidal activity of 2-iodo-N-[(4-methoxy-6-methyl-1,3,5-triazin-2-yl)carbamoyl]benzenesulfonamide and/or its salts, in particular compounds of the formula (I), can also be improved by using vegetable oils. The term vegetable oils is to be understood as meaning oils of oleaginous plant species, such as soybean oil, rapeseed oil, corn oil, sunflower oil, cottonseed oil, linseed oil, coconut oil, palm oil, thistle oil or castor oil, in particular rapeseed oil, and also their transesterification products, for example alkyl esters, such as rapeseed oil methyl ester or rapeseed oil ethyl ester.

The vegetable oils are preferably esters of C₁₀-C₂₂-, preferably C₁₂-C₂₀-fatty acids. The C₁₀-C₂₂-fatty acid esters are, for example, esters of unsaturated or saturated C₁₀-C₂₂-fatty acids, in particular those having an even number of carbon atoms, for example erucic acid, lauric acid, palmitic acid and in particular C₁₈-fatty acids, such as stearic acid, oleic acid, linoleic acid or linolenic acid.

Examples of C₁₀-C₂₂-fatty acid esters are esters obtained by reacting glycerol or glycol with the C₁₀-C₂₂-fatty acids contained, for example, in oils of oleaginous plant species, or C₁-C₂₀-alkyl-C₁₀-C₂₂-fatty acid esters which can be obtained, for example, by transesterification of the aforementioned glycerol- or glycol-C₁₀-C₂₂-fatty acid esters with C₁-C₂₀-alcohols (for example methanol, ethanol, propanol or butanol).

The transesterification can be carried out by known methods as described, for example, in Römpp Chemie Lexikon, 9th edition, Volume 2, page 1343, Thieme Verlag Stuttgart.

Preferred C₁-C₂₀-alkyl-C₁₀-C₂₂-fatty acid esters are methyl esters, ethyl esters, propyl esters, butyl esters, 2-ethylhexyl esters and dodecyl esters. Preferred glycol- and glycerol-C₁₀-C₂₂-fatty acid esters are the uniform or mixed glycol esters and glycerol esters of C₁₀-C₂₂-fatty acids, in particular fatty acids having an even number of carbon atoms, for example erucic acid, lauric acid, palmitic acid and, in particular, C₁₈-fatty acids, such as stearic acid, oleic acid, linoleic acid or linolenic acid.

In the herbicidal compositions according to the invention, the vegetable oils can be present, for example, in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob® B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

In a further embodiment, the present invention comprises combinations with the vegetable oils mentioned above, such as rapeseed oil, preferably in the form of commercially available oil-containing formulation additives, in particular those based on rapeseed oil, such as Hasten® (Victorian Chemical Company, Australia, hereinbelow referred to as Hasten, main ingredient: rapeseed oil ethyl ester), Actirob® B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

It is furthermore possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

The formulations generally comprise between 0.1 and 95 percent by weight of active compound, preferably between 0.5 and 90%.

2-Iodo-N-[(4-methoxy-6-methyl-1,3,5-triazin-2-yl)carbamoyl]benzenesulfonamide and its salts, preferably its salts according to the compounds of the formula (I), as such or in their formulations, can also be used as a mixture with other agrochemically active compounds, such as known herbicides, for controlling unwanted vegetation, for example for controlling weeds or for controlling unwanted crop plants, finished formulations or tank mixes, for example, being possible.

Suitable as combination partners for 2-iodo-N-[(4-methoxy-6-methyl-1,3,5-triazin-2-yl)carbamoyl]benzenesulfonamide and its salts, preferably its salts according to the compounds of the formula (I), for example in formulations of mixtures or in tank mixes are, for example, known agrochemically active compounds, preferably herbicidally active compounds whose action is based on the inhibition of, for example, acetolactate synthase, acetyl-coenzyme-A carboxylase, PS I, PS II, HPPDO, phytoene desaturase, protoporphyrinogen oxidase, glutamine synthetase, cellulose biosynthesis, 5-enolpyruvylshikimate 3-phosphate synthetase. Such compounds and also other compounds which can be used, in some cases having an unknown or a different mechanism of action, are described, for example, in Weed Research 26, 441-445 (1986), or in “The Pesticide Manual”, 12th edition 2000, or 13th edition 2003 or 14th edition 2006/2007, or in the corresponding “e-Pesticide Manual”, version 4 (2006), all published by the British Crop Protection Council, (hereinbelow also referred to as “PM” for short), and in the literature cited therein. Lists of “common names” are also available in “The Compendium of Pesticide Common Names” on the Internet. Examples of herbicides known from the literature which may be combined with 2-iodo-N-[(4-methoxy-6-methyl-1,3,5-triazin-2-yl)carbamoyl]benzenesulfonamide or the compounds of the formula (I) are the active compounds from the following list: (note: the herbicides are referred to either by the “common name” according to the International Organization for Standardization (ISO) or by the chemical name, if appropriate together with a customary code number and in each case comprise all use forms, such as acids, salts, esters and isomers, such as stereoisomers and optical isomers, in particular the commercial form or the commercial forms, unless the context indicates otherwise. In the case of sulfonamides such as sulfonylureas, salts also include salts formed by exchange of a hydrogen atom at the sulfonamide group for a cation. Here, one and in some cases also a plurality of use forms are mentioned):

acetochlor; acibenzolar-S-methyl; acifluorfen(-sodium); aclonifen; AD-67; AKH 7088, i.e. [[[1[5-[2-chloro-4-(trifluoromethyl)phenoxy]-2-nitrophenyl]-2-methoxyethylidene]-amino]oxy]acetic acid and methyl [[[1[5-[2-chloro-4-(trifluoromethyl)phenoxy]-2-nitrophenyl]-2-methoxyethylidene]amino]oxy]acetate; alachlor; alloxydim(-sodium); ametryn; amicarbazone, amidochlor, amidosulfuron; aminopyralid; amitrol; ammonium pelargonate; AMS, i.e. ammonium sulfamate; ancimidol; anilofos; asulam; atrazine; aviglycine; azafenidin, azimsulfuron (DPX-A8947); aziprotryn; barban; BAS 516H, i.e. 5-fluoro-2-phenyl-4H-3,1-benzoxazin-4-one; beflubutamid (UBH-509), benazolin(-ethyl); bencarbazone; benfluralin; benfuresate; bensulfuron(-methyl); bensulide; bentazone; benzfendizone; benzobicyclon, benzofenap; benzofluor; benzoylprop(-ethyl); benzthiazuron; bialanaphos; bifenox; bispyribac(-sodium) (KIH-2023); borax; bromacil; bromobutide; bromofenoxim; bromoxynil; bromuron; buminafos; busoxinone; butachlor; butafenacil; butamifos; butenachlor (KH-218); buthidazole; butralin; butroxydim; butylate; cafenstrole (CH-900); caloxydim; carbetamide; carfentrazone(-ethyl); catechin; CDAA, i.e. 2-chloro-N,N-di-2-propenylacetamide; CDEC, i.e. 2-chloroallyl diethyldithiocarbamate; chlormesulon; chlomethoxyfen; chloramben; chlorazifop-butyl; chlorbromuron; chlorbufam; chlorfenac; chlorfenprop; chlorflurecol(-methyl); chlorflurenol(-methyl); chloridazon; chlorimuron(-ethyl); chlormequat(-chloride); chlornitrofen; chlorophthalim (MK-616); chlorotoluron; chloroxuron; chlorpropham; chlorsulfuron; chlorthal-dimethyl; chlorthiamid; chlortoluron; cinidon(-methyl and -ethyl); cinmethylin; cinosulfuron; clefoxydim; clethodim; clodinafop and its ester derivatives (for example clodinafop-propargyl); clofencet; clomazone; clomeprop; cloprop; cloproxydim; clopyralid; clopyrasulfuron(-methyl); cloransulam(-methyl); cumyluron (JC 940); cyanamide; cyanazine; cycloate; cyclosulfamuron (AC 104); cycloxydim; cycluron; cyhalofop and its ester derivatives (for example butyl ester, DEH-112); cyperquat; cyprazine; cyprazole; daimuron; 2,4-D; 2,4-DB; dalapon; daminozide; dazomet; n-decanol; desmedipham; desmetryn; di-allate; dicamba; dichlobenil; dichlormid; dichlorprop(-P) salts; diclofop and its esters, such as diclofop-methyl; diclofop-P(-methyl); diclosulam; diethatyl(-ethyl); difenoxuron; difenzoquat(-metilsulfate); diflufenican; diflufenzopyr(-sodium); dimefuron; dimepiperate; dimethachlor; dimethametryn; dimethazone; dimethenamid (SAN-582H); dimethenamide-P; dimethylarsinic acid; dimethipin; dimetrasulfuron; dimexyflam; dinitramine; dinoseb; dinoterb; diphenamid; dipropetryn; diquat salts; dithiopyr; diuron; DNOC; eglinazine-ethyl; EL 77, i.e. 5-cyano-1-(1,1-dimethylethyl)-N-methyl-1H-pyrazole-4-carboxamide; endothal; epoprodan; EPTC; esprocarb; ethalfluralin; ethametsulfuron-methyl; ethephon; ethidimuron; ethiozin; ethofumesate; ethoxyfen and its esters (for example ethyl ester, HN-252); ethoxysulfuron; etobenzanid (HW 52); F5231, i.e. N-[2-chloro-4-fluoro-5-[4-(3-fluoropropyl)-4,5-dihydro-5-oxo-1H-tetrazol-1-yl]phenyl]ethanesulfonamide; fenchlorazole(-ethyl); fenclorim; fenoprop; fenoxan, fenoxaprop and fenoxaprop-P and also their esters, for example fenoxaprop-P-ethyl and fenoxaprop-ethyl; fenoxydim; fentrazamide; fenuron; ferrous sulfate; flamprop(-methyl- or isopropyl- or isopropyl-L); flamprop-M(-methyl or -isopropyl); flazasulfuron; floazulate (JV-485); florasulam; fluazifop and fluazifop-P and their esters, for example fluazifop-butyl and fluazifop-P-butyl; fluazolate; flucarbazone(-sodium); flucetosulfuron; fluchloralin; flufenacet; flufenpyr(-ethyl); flumetralin; flumetsulam; flumeturon; flumiclorac(-pentyl); flumioxazin (S-482); flumipropyn; fluometuron; fluorochloridone; fluorodifen; fluoroglycofen(-ethyl); flupoxam (KNW-739); flupropacil (UBIC-4243); flupropanoate; flupyrsulfuron(-methyl)(-sodium); flurenol(-butyl); fluridone; fluorochloridone; fluoroxypyr(-meptyl); flurprimidol; flurtamone; fluthiacet(-methyl) (KIH-9201); fluthiamide; fluxofenim; fomesafen; foramsulfuron; forchlorfenuron; fosamine; furyloxyfen; gibberillic acid; glufosinate(-ammonium); glyphosate(-isopropylammonium); halosafen; halosulfuron(-methyl); haloxyfop and its esters; haloxyfop-P(═R-haloxyfop) and its esters; HC-252; hexazinone; HNPC-C9908, i.e. methyl 2-[[[[[4-methoxy-6-(methylthio)-2-pyrimidinyl]amino]carbonyl]amino]sulfonyl]benzoate; imazamethabenz(-methyl); imazamox; imazapic; imazapyr; imazaquin and salts, such as the ammonium salt; imazethapyr; imazosulfuron; inabenfide; indanofan; iodosulfuron-methyl(-sodium); ioxynil; isocarbamid; isopropalin; isoproturon; isouron; isoxaben; isoxachlortole; isoxaflutole; isoxapyrifop; karbutilate; lactofen; lenacil; linuron; maleic hyrazide (MH); MBTA; MCPA; MCPB; mecoprop(-P); mefenacet; mefluidide; mepiquat(-chloride); mesosulfuron(-methyl); mesotrione; metam; metamifop; metamitron; metazachlor; methabenzthiazuron; metham; methazole; methoxyphenone; methylarsonic acid; methylcyclopropene; methyldymron; methylisothiocyanate; methabenzthiazuron; metobenzuron; metobromuron; (alpha-)metolachlor; metosulam (XRD 511); metoxuron; metribuzin; metsulfuron-methyl; molinate; monalide; monocarbamide dihydrogensulfate; monolinuron; monuron; monosulfuron; MT 128, i.e. 6-chloro-N-(3-chloro-2-propenyl)-5-methyl-N-phenyl-3-pyridazinamine; MT 5950, i.e. N-[3-chloro-4-(1-methylethyl)phenyl]-2-methylpentanamide; naproanilide; napropamide; naptalam; NC 310, i.e. 4-(2,4-dichlorobenzoyl)-1-methyl-5-benzyloxypyrazole; neburon; nicosulfuron; nipyraclofen; nitralin; nitrofen; nitrophenolate mixture; nitrofluorfen; nonanoic acid; norflurazon; orbencarb; orthosulfamuron; oxabetrinil; oryzalin; oxadiargyl (RP-020630); oxadiazon; oxasulfuron; oxaziclomefone; oxyfluorfen; paclobutrazol; paraquat(-dichloride); pebulate; pelargonic acid; pendimethalin; penoxulam; pentachlorophenol; pentanochlor; pentoxazone; perfluidone; pethoxamid; phenisopham; phenmedipham; picloram; picolinafen; pinoxaden; piperophos; piributicarb; pirifenop-butyl; pretilachlor; primisulfuron(-methyl); probenazole; procarbazone-(sodium); procyazine; prodiamine; profluralin; profoxydim; prohexadione(-calcium); prohydrojasmon; proglinazine(-ethyl); prometon; prometryn; propachlor; propanil; propaquizafop and its esters; propazine; propham; propisochlor; propoxycarbazone(-sodium) (MKH-6561); propyzamide; prosulfalin; prosulfocarb; prosulfuron (CGA-152005); prynachlor; pyraclonil; pyraflufen(-ethyl) (ET-751); pyrasulfotole; pyrazolynate; pyrazon; pyrazosulfuron(-ethyl); pyrazoxyfen; pyribambenz-isopropyl (ZJ 0702); pyrimbambenz-propyl (ZJ 0273); pyribenzoxim; pyributicarb; pyridafol; pyridate; pyriftalid; pyriminobac(-methyl) (KIH-6127); pyrimisulfan (KIH-5996); pyrithiobac(-sodium) (KIH-2031); pyroxasulfone (KIH-485); pyroxofop and its esters (for example propargyl ester); pyroxsulam; quinclorac; quinmerac; quinoclamine; quinofop and its ester derivatives, quizalofop and quizalofop-P and their ester derivatives, for example quizalofop-ethyl; quizalofop-P-tefuryl and -ethyl; renriduron; rimsulfuron (DPX-E 9636); S 275, i.e. 2 [4-chloro-2-fluoro-5-(2-propynyloxy)phenyl]-4,5,6,7-tetrahydro-2H-indazole; secbumeton; sethoxydim; siduron; simazine; simetryn; sintofen; SN 106279, i.e. 2 [[7-[2-chloro-4-(trifluoromethyl)phenoxy]-2-naphthalenyl]oxy]propanoic acid and methyl 2-[[7-[2-chloro 4-(trifluoromethyl)phenoxy]-2-naphthalenyl]oxy]propanoate; sulcotrione; sulfentrazone (FMC-97285, F-6285); sulfazuron; sulfometuron(-methyl); sulfosate (ICI-A0224); sulfosulfuron; TCA(-sodium); tebutam (GCP-5544); tebuthiuron; tecnacene; tefuryltrione; tembotrione; tepraloxydim; terbacil; terbucarb; terbuchlor; terbumeton; terbuthylazine; terbutryn; TFH 450, i.e. N,N-diethyl-3-[(2-ethyl-6-methylphenyl)sulfonyl]-1H-1,2,4-triazole-1-carboxamide; thenylchlor (NSK-850); thiafluamide, thiazafluoron; thiazopyr (Mon-13200); thidiazimin (SN-24085); thidiazuron; thiencarbazone(-methyl); thifensulfuron(-methyl); thiobencarb; Ti 35; tiocarbazil; topramezone; tralkoxydim; tri-allate; triasulfuron; triaziflam; triazofenamide; tribenuron(-methyl); triclopyr; tridiphane; trietazine; trifloxysulfuron(-sodium); trifluralin; triflusulfuron and esters (for example methyl ester, DPX-66037); trimeturon; trinexapac; tritosulfuron; tsitodef; uniconazole; vernolate; WL 110547, i.e. 5-phenoxy-1-[3-(trifluoromethyl)phenyl]-1H-tetrazole; D-489; ET-751; KIH-218; KIH-485; KIH-509; KPP-300; LS 82-556; NC-324; NC-330; DPX-N8189; SC-0774; DOWCO-535; DK-8910; V-53482; PP-600; MBH-001; TH-547; SYN-523; IDH-100; SYP-249; HOK-201; IR-6396; MTB-951; NC-620.

In the crops mentioned above, 2-iodo-N-[(4-methoxy-6-methyl-1,3,5-triazin-2-yl)carbamoyl]benzenesulfonamide and its salts, preferably its salts according to the compounds of the formula (I), already have very good to satisfactory selectivity; however, in principle, in some crops and especially also in the case of mixtures with other less selective herbicides, phytotoxicities on the crop plants may occur. In this respect, combinations of 2-iodo-N-[(4-methoxy-6-methyl-1,3,5-triazin-2-yl)carbamoyl]benzenesulfonamide and its salts according to the invention, in particular of compounds of the formula (I), which comprise these compounds in combination with other herbicides or pesticides and safeners are of particular interest. The safeners, which are used in an antidotically effective amount, reduce the phytotoxic side effects of the herbicides/pesticides employed, for example in economically important crops, such as cereals (such as, for example, wheat, barley, rye, corn, rice, millet, triticale or oats), sugar beet, sugar cane, oilseed rape, cotton and soybeans, preferably cereals.

The safeners are preferably selected from the group consisting of:

A) Compounds of the formula (S-I)

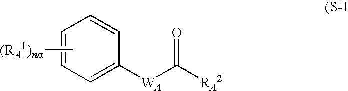

where the symbols and indices have the following meanings:
n_{A} is a natural number from 0 to 5, preferably from 0 to 3;
R_{A}¹ is halogen, (C₁-C₄)-alkyl, (C₁-C₄)-alkoxy, nitro or (C₁-C₄)-haloalkyl;
W_{A} is an unsubstituted or substituted divalent heterocyclic radical from the group consisting of partially unsaturated or aromatic five-membered heterocycles having 1 to 3 hetero ring atoms of the type N or O, where at least one nitrogen atom and at most one oxygen atom is present in the ring, preferably a radical from the group consisting of (W_{A}¹) to (W_{A}⁴),

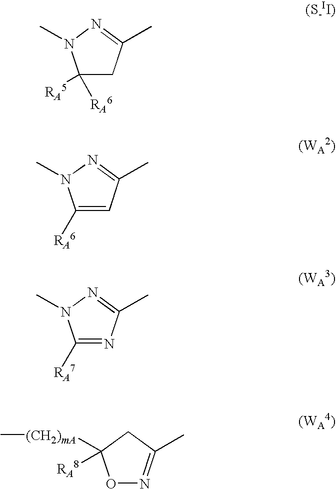

m_{A} is 0 or 1;
R_{A}² is OR_{A}³, SR_{A}³ or NR_{A}³R_{A}⁴ or a saturated
   or unsaturated 3- to 7-membered heterocycle having at least one nitrogen atom and up to 3 heteroatoms, preferably from the group consisting of 0 and S, which is attached via the nitrogen atom to the carbonyl group in (S-I) and which is unsubstituted or substituted by radicals from the group consisting of (C₁-C₄)-alkyl, (C₁-C₄)-alkoxy and optionally substituted phenyl, preferably a radical of the formula OR_{A}³, NHR_{A}⁴ or N(CH₃)₂, in particular of the formula OR_{A}³;
R_{A}³ is hydrogen or an unsubstituted or substituted aliphatic hydrocarbon radical having preferably a total of 1 to 18 carbon atoms;
R_{A}⁴ is hydrogen, (C₁-C₆)-alkyl, (C₁-C₆)-alkoxy or substituted or unsubstituted phenyl;
R_{A}⁵ is H, (C₁-C₈)-alkyl, (C₁-C₈)-haloalkyl, (C₁-C₄)-alkoxy-(C₁-C₈)-alkyl, cyano or COOR_{A}⁹, where R_{A}⁹ is hydrogen, (C₁-C₈)-alkyl, (C₁-C₈)-haloalkyl, (C₁-C₄)-alkoxy-(C₁-C₄)-alkyl, (C₁-C₆)-hydroxyalkyl, (C₃-C₁₂)-cycloalkyl or tri-(C₁-C₄)-alkylsilyl;
R_{A}⁶, R_{A}⁷, R_{A}⁸ are identical or different and are hydrogen, (C₁-C₈)-alkyl, (C₁-C₈)-haloalkyl, (C₃-C₁₂)-cycloalkyl or substituted or unsubstituted phenyl;
   preferably:
   a) compounds of the type of dichlorophenylpyrazoline-3-carboxylic acid, preferably compounds such as ethyl 1-(2,4-dichlorophenyl)-5-(ethoxycarbonyl)-5-methyl-2-pyrazoline-3-carboxylate (S1-1) (“mefenpyr-diethyl”, see Pestic. Man.), and related compounds, as described in WO 91/07874;
   b) derivatives of dichlorophenylpyrazolecarboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806;
   c) compounds of the type of the triazolecarboxylic acids, preferably compounds such as fenchlorazole(-ethyl ester), i.e. ethyl 1-(2,4-dichlorophenyl)-5-trichloro-methyl-(1H)-1,2,4-triazole-3-carboxylate (S1-6), and related compounds, as described in EP-A-174 562 and EP-A-346 620;
   d) compounds of the type of 5-benzyl- or 5-phenyl-2-isoxazoline-3-carboxylic acid or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or ethyl 5,5-diphenyl-2-isoxazolinecarboxylate (S1-9) (“isoxadifen-ethyl”) or n-propyl 5,5-diphenyl-2-isoxazolinecarboxylate (S1-10) or ethyl 5-(4-fluorophenyl)-5-phenyl-2-isoxazoline-3-carboxylate (S1-11), as described in the patent application WO-A-95/07897.
   B) Quinoline derivatives of the formula (S-II)

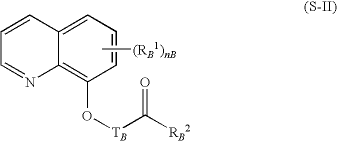

where the symbols and indices have the following meanings:
R_{B}¹ is halogen, (C₁-C₄)-alkyl, (C₁-C₄)-alkoxy, nitro or (C₁-C₄)-haloalkyl;
n_{B} is a natural number from 0 to 5, preferably from 0 to 3;
R_{B}² OR_{B}³, SR_{B}³ or NR_{B}³R_{B}⁴ or a saturated
or unsaturated 3- to 7-membered heterocycle having at least one nitrogen atom and up to 3 heteroatoms, preferably from the group consisting of O and S, which is attached via the nitrogen atom to the carbonyl group in (S-II) and is unsubstituted or substituted by radicals from the group consisting of (C₁-C₄)-alkyl, (C₁-C₄)-alkoxy or optionally substituted phenyl, preferably a radical of the formula OR_{B}³, NHR_{B}⁴ or N(CH₃)₂, in particular of the formula OR_{B}³;
R_{B}³ is hydrogen or an unsubstituted or substituted aliphatic hydrocarbon radical having preferably a total of 1 to 18 carbon atoms;
R_{B}⁴ is hydrogen, (C₁-C₆)-alkyl, (C₁-C₆)-alkoxy or substituted or unsubstituted phenyl;
T_{B} is a (C₁- or C₂)-alkanediyl chain which is unsubstituted or substituted by one or two (C₁-C₄)-alkyl radicals or by [(C₁-C₃)-alkoxy]carbonyl;
preferably:
a) compounds of the type of 8-quinolinoxyacetic acid (S2), preferably
1-methylhexyl (5-chloro-8-quinolinoxy)acetate (common name “cloquintocet-mexyl” (S2-1) (see Pesticide Manual),
1,3-dimethylbut-1-yl (5-chloro-8-quinolinoxy)acetate (S2-2),
4-allyloxybutyl (5-chloro-8-quinolinoxy)acetate (S2-3),
1-allyloxyprop-2-yl (5-chloro-8-quinolinoxy)acetate (S2-4),
ethyl (5-chloro-8-quinolinoxy)acetate (S2-5),
methyl (5-chloro-8-quinolinoxy)acetate (S2-6),
allyl (5-chloro-8-quinolinoxy)acetate (S2-7),
2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds, as described in EP-A-86 750, EP-A-94 349 and EP-A-191 736 or EP-A-0 492 366, and also their hydrates and salts, as described in WO-A-2002/034048;
   b) compounds of the type of (5-chloro-8-quinolinoxy)malonic acid, preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
   C) Compounds of the formula (S-III)

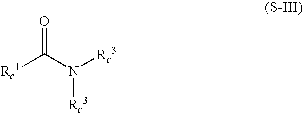

where the symbols and indices have the following meanings:
R_{C}¹ is (C₁-C₄)-alkyl, (C₁-C₄)-haloalkyl, (C₂-C₄)-alkenyl, (C₂-C₄)-haloalkenyl, (C₃-C₇)-cycloalkyl, preferably dichloromethyl;
R_{C}², R_{C}³ are identical or different and are hydrogen, (C₁-C₄)-alkyl, (C₂-C₄)-alkenyl, (C₂-C₄)-alkynyl, (C₁-C₄)-haloalkyl, (C₂-C₄)-haloalkenyl, (C₁-C₄)-alkylcarbamoyl-(C₁-C₄)-alkyl, (C₂-C₄)-alkenylcarbamoyl-(C₁-C₄)-alkyl, (C₁-C₄)-alkoxy-(C₁-C₄)-alkyl, dioxolanyl-(C₁-C₄)-alkyl, thiazolyl, furyl, furylalkyl, thienyl, piperidyl, substituted or unsubstituted phenyl, or R_{C}² and R_{C}³ together form a substituted or unsubstituted heterocyclic ring,
preferably an oxazolidine, thiazolidine, piperidine, morpholine, hexahydropyrimidine or benzoxazine ring;
preferably:
active compounds of the type of the dichloroacetamides which are frequently used as pre-emergence safeners (soil-acting safeners), such as, for example,
“dichlormid” (see Pestic.Man.) (=N,N-diallyl-2,2-dichloroacetamide),
“R-29148” (=3-dichloroacetyl-2,2,5-trimethyl-1,3-oxazolidine from Stauffer),
“R-28725” (=3-dichloroacetyl-2,2,-dimethyl-1,3-oxazolidine from Stauffer),
“benoxacor” (see Pestic. Man.) (=4-dichloroacetyl-3,4-dihydro-3-methyl-2H-1,4-benzoxazine),
“PPG-1292” (=N-allyl-N-[(1,3-dioxolan-2-yl)methyl]dichloroacetamide from PPG Industries),
“DKA-24” (=N-allyl-N-[(allylaminocarbonyl)methyl]dichloroacetamide from Sagro-Chem),
“AD-67” or “MON 4660” (=3-dichloroacetyl-1-oxa-3-aza-spiro[4,5]decane from Nitrokemia or Monsanto),
“TI-35” (=1-dichloroacetylazepane from TRI-Chemical RT)
“diclonon” (dicyclonone) or “BAS145138” or “LAB145138” (=3-dichloroacetyl-2,5,5-trimethyl-1,3-diazabicyclo[4.3.0]nonane from BASF) and
“furilazole” or “MON 13900” (see Pestic. Man.) (=(RS)-3-dichloroacetyl-5-(2-furyl)-2,2-dimethyloxazolidine).
   D) N-Acylsulfonamides of the formula (S-IV) and their salts

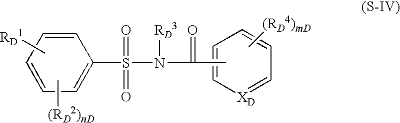

in which

### X_{D} is CH or N;

### R_{D}¹ is CO—NR_{D}⁵R_{D}⁶ or NHCO—R_{D}⁷;

R_{D}² is halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl;
R_{D}³ is hydrogen, (C₁-C₄)-alkyl, (C₂-C₄)-alkenyl or (C₂-C₄)-alkynyl;
R_{D}⁴ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
R_{D}⁵ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl, phenyl or 3- to 6-membered heterocyclyl containing v_{D} heteroatoms from the group consisting of nitrogen, oxygen and sulfur, where the seven last-mentioned radicals are substituted by v_{D} substituents from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R_{D}⁶ is hydrogen, (C₁-C₆)-alkyl, (C₂-C₆)-alkenyl or (C₂-C₆)-alkynyl, where the three last-mentioned radicals are substituted by v_{D} radicals from the group consisting of halogen, hydroxy, (C₁-C₄)-alkyl, (C₁-C₄)-alkoxy and (C₁-C₄)-alkylthio, or
R_{D}⁵ and R_{D}⁶ together with the nitrogen atom carrying them form a pyrrolidinyl or piperidinyl radical;
R_{D}⁷ is hydrogen, (C₁-C₄)-alkylamino, di-(C₁-C₄)-alkylamino, (C₁-C₆)-alkyl, (C₃-C₆)-cycloalkyl, where the 2 last-mentioned radicals are substituted by v_{D} substituents from the group consisting of halogen, (C₁-C₄)-alkoxy, halogen-(C₁-C₆)-alkoxy and (C₁-C₄)-alkylthio and, in the case of cyclic radicals, also (C₁-C₄)-alkyl and (C₁-C₄)-haloalkyl;
n_{D} is 0, 1 or 2;
m_{D} is 1 or 2;

### VD is 0, 1, 2 or 3;

from among these, preference is given to compounds of the type of the N-acylsulfonamides, for example of the formula (S-V) below, which are known, for example, from WO 97/45016,

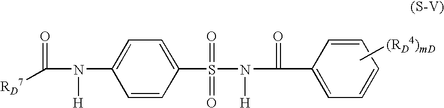

in which
R_{D}⁷ is (C₁-C₆)-alkyl, (C₃-C₆)-cycloalkyl, where the 2 last-mentioned radicals are substituted by v_{D} substituents from the group consisting of halogen, (C₁-C₄)-alkoxy, halogen-(C₁-C₆)-alkoxy and (C₁-C₄)-alkylthio and, in the case of cyclic radicals, also (C₁-C₄)-alkyl and (C₁-C₄)-haloalkyl;
R_{D}⁴ is halogen, (C₁-C₄)-alkyl, (C₁-C₄)-alkoxy, CF₃,
m_{D} is 1 or 2;

### VD is 0, 1, 2 or 3;

and also
acylsulfamoylbenzamides, for example of the formula (S-VI) below, which are known, for example, from WO 99/16744,

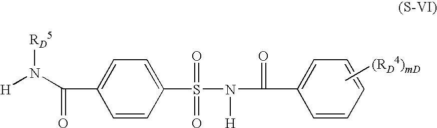

for example those in which
R_{D}⁵=cyclopropyl and (R_{D}⁴)=2-OMe (“cyprosulfamide”, S3-1),
R_{D}⁵=cyclopropyl and (R_{D}⁴)=5-Cl-2-OMe (S3-2),
R_{D}⁵=ethyl and (R_{D}⁴)=2-OMe (S3-3),
R_{D}⁵=isopropyl and (R_{D}⁴)=5-Cl-2-OMe (S3-4) and
R_{D}⁵=isopropyl and (R_{D}⁴)=2-OMe (S3-5);
and also
compounds of the type of the N-acylsulfamoylphenylureas of the formula (S-VII), which are known, for example, from EP-A-365484,

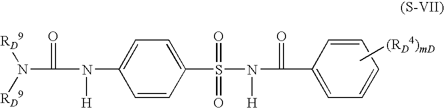

in which
R_{D}⁸ and R_{D}⁹ independently of one another are hydrogen, (C₁-C₈)-alkyl, (C₃-C₈)-cycloalkyl, (C₃-C₆)-alkenyl, (C₃-C₆)-alkynyl,
R_{D}⁴ is halogen, (C₁-C₄)-alkyl, (C₁-C₄)-alkoxy, CF₃
m_{D} is 1 or 2;
from among these in particular
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea,
1-[4-(N-naphthoylsulfamoyl)phenyl]-3,3-dimethylurea.
   G) Active compounds from the class of the hydroxyaromatics and aromatic-aliphatic carboxylic acid derivatives, for example
   ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 1,2-dihydro-2-oxo-6-trifluoromethylpyridine-3-carboxamide, 2-hydroxycinnamic acid, 2,4-dichlorocinnamic acid, as described in WO 2004084631, WO 2005015994, WO 2006007981, WO 2005016001.
   H) Active compounds from the class of the 1,2-dihydroquinoxalin-2-ones, for example
   1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydro-quinoxalin-2-one, as described in WO 2005112630.
   I) Active compounds which, in addition to a herbicidal activity against harmful plants, also have safener action on crop plants such as rice, such as, for example, “dimepiperate” or “MY-93” (see Pestic. Man.) (═S-1-methyl-1-phenylethyl piperidine-1-thiocarboxylate), which is known as safener for rice against damage by the herbicide molinate,
   “daimuron” or “SK 23” (see Pestic. Man.) (=1-(1-methyl-1-phenylethyl)-3-p-tolyl-urea), which is known as safener for rice against damage by the herbicide imazosulfuron,
   “cumyluron”=“JC-940” (=3-(2-chlorophenylmethyl)-1-(1-methyl-1-phenylethyl)urea, see JP-A-60087254), which is known as safener for rice against damage by a number of herbicides,
   “methoxyphenone” or “NK 049” (=3,3′-dimethyl-4-methoxybenzophenone), which is known as safener for rice against damage by a number of herbicides,
   “CSB” (=1-bromo-4-(chloromethylsulfonyl)benzene) (CAS Reg. No. 54091-06-4 from Kumiai), which is known as safener against damage by a number of herbicides in rice.
   K) Compounds of the formula (S-IX),
   as described in WO-A-1998/38856

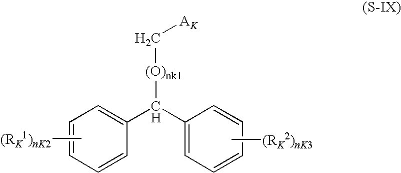

where the symbols and indices have the following meanings:
R_{K}¹, R_{K}² independently of one another are halogen, (C₁-C₄)-alkyl, (C₁-C₄)-alkoxy, (C₁-C₄)-haloalkyl, (C₁-C₄)-alkylamino, di-(C₁-C₄)-alkylamino, nitro;

### A_{K} is COOR_{K}³ or COOR_{K}⁴

R_{K}³, R_{K}⁴ independently of one another are hydrogen, (C₁-C₄)-alkyl, (C₂-C₆)-alkenyl, (C₂-C₄)-alkynyl, cyanoalkyl, (C₁-C₄)-haloalkyl, phenyl, nitrophenyl, benzyl, halobenzyl, pyridinylalkyl or alkylammonium,

n_{K}¹ is 0 or 1,
n_{K}², n_{K}³ independently of one another are 0, 1 or 2
preferably: methyl (diphenylmethoxy)acetate (CAS reg no: 41858-19-9).
L) Compounds of the formula (S-X)
as described in WO A-98/27049

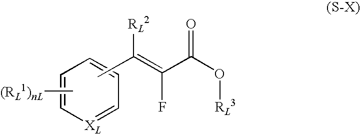

where the symbols and indices have the following meanings:
X_{L} is CH or N,
n_{L} is, in the case that X═N, an integer from 0 to 4 and,
   in the case that X═CH, an integer from 0 to 5,
R_{L}¹ is halogen, (C₁-C₄)-alkyl, (C₁-C₄)-haloalkyl, (C₁-C₄)-alkoxy, (C₁-C₄)-haloalkoxy, nitro, (C₁-C₄)-alkylthio, (C₁-C₄)-alkylsulfonyl, (C₁-C₄)-alkoxycarbonyl, optionally substituted phenyl, optionally substituted phenoxy,
R_{L}² is hydrogen or (C₁-C₄)-alkyl,
R_{L}³ is hydrogen, (C₁-C₈-alkyl, (C₂-C₄)-alkenyl, (C₂-C₄)-alkynyl or aryl, where each of the carbon-containing radicals mentioned above is unsubstituted or substituted by one or more, preferably by up to three, identical or different radicals from the group consisting of halogen and alkoxy; or salts thereof.
   M) Active compounds from the class of the 3-(5-tetrazolylcarbonyl)-2-quinolones, for example 1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No.: 95855-00-8), as described in WO-A-1999000020.
   N) Compounds of the formula (S-XI) or (S-XII)
   as described in WO-A-2007023719 and WO-A-2007023764

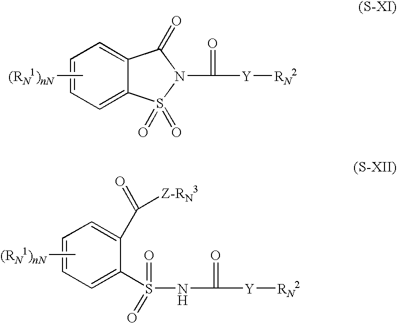

in which
R_{N}¹ is halogen, (C₁-C₄)-alkyl, methoxy, nitro, cyano, CF₃, OCF₃
Y, Z independently of one another are O or S,
n_{N} is an integer from 0 to 4,
R_{N}² is (C₁-C₁₆)-alkyl, (C₂-C₆)-alkenyl, (C₃-C₆)-cycloalkyl, aryl, benzyl, halobenzyl,
R_{N}³ is hydrogen, (C₁-C₆)alkyl.
O) One or more compounds from the group consisting of:
1,8-naphthalic anhydride,
O,O-diethyl S-2-ethylthioethyl phosphorodithioate (disulfoton),
4-chlorophenyl methylcarbamate (mephenate),
O,O-diethyl O-phenyl phosphorothioate (dietholate),
4-carboxy-3,4-dihydro-2H-1-benzopyran-4-acetic acid (CL-304415, CAS Reg. No.: 31541-57-8),
2-propenyl 1-oxa-4-azaspiro[4.5]decane-4-carbodithioate (MG-838, CAS Reg. No.: 133993-74-5),
methyl [(3-oxo-1H-2-benzothiopyran-4(3H)-ylidene)methoxy]acetate (from WO-A-98/13361; CAS Reg. No.: 205121-04-6),
cyanomethoxyimino(phenyl)acetonitrile (cyometrinil),
1,3-dioxolan-2-ylmethoxyimino(phenyl)acetonitrile (oxabetrinil),
4′-chloro-2,2,2-trifluoroacetophenone O-1,3-dioxolan-2-ylmethyloxime (fluxofenim),
4,6-dichloro-2-phenylpyrimidine (fenclorim),
benzyl 2-chloro-4-trifluoromethyl-1,3-thiazole-5-carboxylate (flurazole),
2-dichloromethyl-2-methyl-1,3-dioxolane (MG-191),
   including the stereoisomers, and the salts customary in agriculture.

Some of the safeners are already known as herbicides and accordingly, in addition to the herbicidal activity against harmful plants, also act by protecting the crop plants.

Suitable herbicidal combination partners of 2-iodo-N-[(4-methoxy-6-methyl-1,3,5-triazin-2-yl)carbamoyl]benzenesulfonamide and/or its salts, in particular compounds of the formula (I), for applications in barley and other crop plants are, preferably, compounds which are selective in barley or other crop plants, such as, for example, amidosulfuron or fenoxaprop-ethyl, iodosulfuron, flufenacet, isoproturon, flurtamone, diflufenacet, foramsulfuron, fentrazamide, thiencarbazone-methyl, mesosulfuron(-methyl), pyrasulfotole, isoxaflutole, tembotrione, bispyribac(-sodium), propoxycarbazone(-sodium) or flucarbazone(-sodium).

Mixtures of 2-iodo-N-[(4-methoxy-6-methyl-1,3,5-triazin-2-yl)carbamoyl]benzenesulfonamide and/or its salts, in particular compounds of the formula (I), with other known active compounds, such as fungicides, insecticides, acaricides, nematicides, safeners, bird repellents, plant nutrients and agents which improve soil structure, are also possible.

2-Iodo-N-[(4-methoxy-6-methyl-1,3,5-triazin-2-yl)carbamoyl]benzenesulfonamide and its salts, preferably its salts according to the compounds of the formula (I), can be used as such, in the form of their formulations or in the use forms prepared therefrom by further dilution, such as ready-to-use solutions, suspensions, emulsions, powders, pastes and granules. They are used in a customary manner, for example by watering, spraying, atomizing or broadcasting.

The present invention furthermore relates to a process for controlling unwanted vegetation (a) by the pre-emergence method (PE) in crop plants such as wheat (durum wheat and common wheat), corn, soybeans, sugar beet, sugar cane, rice, cotton, beans, peas, flax, barley, oats, rye, triticale, potatoes and millet (sorghum) and also (b) by the post-emergence method (PO) in crop plants such as barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops, preferably in barley, oats, rye and triticale, which comprises applying one or more compounds of 2-iodo-N-[(4-methoxy-6-methyl-1,3,5-triazin-2-yl)carbamoyl]benzenesulfonamide and its salts, preferably its salts according to the compounds of the formula (I), onto the plants (for example harmful plants such as mono- or dicotyledonous weeds or unwanted crop plants), the seed (for example grains, seeds or vegetative propagation organs, such as tubers or shoot parts with buds) or the area in which the plants grow (for example the area under cultivation). They can be applied, for example, prior to sowing or either before or after emergence of the plants. Pre-sowing application can take place, for example, by spraying or incorporation into the soil. Split applications, for example by early pre-emergence followed later by post-emergence application, are also possible. Preferred is an application to the emerged harmful plants, in particular prior to the emergence of the barley.

Preferred for selective use in barley, oats, rye and/or triticale, preferably in barley and/or oats, is an application to emerged plants, in particular to emerged harmful plants (for example weeds or unwanted crop plants), preferably prior to the emergence of barley, oats, rye and/or triticale, particularly preferably in barley and/or oats, very particularly preferably in barley.

The amount of active compound used can vary within a relatively wide range. It depends essentially on the nature of the desired effect. In general, the application rates are between 0.01 g and 1000 g of active compound per hectare (a.i./ha) of soil surface. Preference is generally given to lower application rates, for example in the range of from 0.1 g to 500 g a.i./ha, preferably between 1 g and 150 g a.i./ha, in particular when applied to emerged plants, especially to emerged harmful plants (for example weeds or unwanted crop plants).

2-Iodo-N-[(4-methoxy-6-methyl-1,3,5-triazin-2-yl)carbamoyl]benzenesulfonamide and/or its salts, preferably compounds of the formula (I), have, for example, excellent selectivity in barley, oats, rye and triticale, where, surprisingly, even at low active compound dosages an excellent activity against the harmful plants typically present in barley, oats, rye and triticale is maintained. In particular, harmful plants which are present in crops of barley, oats, rye and triticale and which are often difficult to control, such as species of the genera Centaurea cyanus, Matricaria species, Veronica spec., Viola spec., Poa annua, Agrostis spica-venti, Stellaria media, Papaver spec., Amaranthus spec., Chenopodium spec. and Sinapis arvensis, are controlled effectively. This also applies to species having partial or complete tolerance or resistance to ALS/ACCase inhibitors, in particular ALS inhibitors of a similar structure.

In addition, 2-iodo-N-[(4-methoxy-6-methyl-1,3,5-triazin-2-yl)carbamoyl]benzenesulfonamide and the salts according to the invention, in particular the compounds of the formula (I), have a favorable effect on follower crops (rotating behavior), i.e. an extremely low, if any, phytotoxicity (such as, for example, in the form of (a) light-green to yellow leaf veins, (b) yellowing of entire plants, (c) delayed plant growth, (d) abnormal development of younger plant parts or the entire plant) on various follower crops sensitive to the salts according to the invention, in particular to the compounds of the formula (I), such as, for example, sugar beet, sunflower or cruciferous plants, such as oilseed rape, mustard and wild turnips, has been observed.

### BIOLOGICAL EXAMPLES

### 1. Pre-Emergence Herbicidal Activity

Seeds or rhizome pieces of mono- and dicotyledonous weeds were placed in sandy loam in cardboard pots and covered with soil. The compounds according to the invention, formulated in the form of wettable powders or emulsion concentrates, were then applied to the surface of the covering soil in the form of aqueous suspensions or emulsions at an application rate of 100 to 8001 of water/ha (converted), at various dosages.

After the treatment, the pots were placed in a greenhouse and kept under good growth conditions for the weeds. Visual scoring of the damage to the plants or the emergence damage was carried out after the emergence of the test plants after a test period of 3 to 4 weeks, by comparison with untreated controls. As shown by the results, the compounds according to the invention have good herbicidal pre-emergence activity against a broad spectrum of weed grasses and broad-leaved weeds.

For example, 2-iodo-N-[(4-methoxy-6-methyl-1,3,5-triazin-2-yl)carbamoyl]benzenesulfonamide and also the compounds Nos. I-1, I-2, I-3, I-4, I-12, I-18, I-19 from Table 1 have very good herbicidal activity against harmful plants such as Lolium multiflorum, Matricaria inodora, Papaver rhoeas, Stellaria media and Viola tricolor when applied by the pre-emergence method at an application rate of 0.1 kg or less of active substance per hectare.

### 2. Post-Emergence Action Against Weeds

Seeds or rhizome pieces of monocotyledonous and dicotyledonous weeds were placed in sandy loam in plastic pots, covered with soil and cultivated in a greenhouse under good growth conditions. Three weeks after sowing, the test plants were treated at the three-leaf stage. The compounds according to the invention, formulated as wettable powders or as emulsion concentrates, were sprayed onto the green parts of the plants at various dosages at an application rate of 100 to 8001 of water/ha (converted). After the test plants had been left to stand in the greenhouse for about 3 to 4 weeks under optimum growth conditions, the activity of the preparations was scored visually in comparison with untreated controls. Applied by the post-emergence method, the compositions according to the invention likewise have good herbicidal activity against a broad spectrum of economically important weed grasses and broad-leaved weeds.

For example, 2-iodo-N-[(4-methoxy-6-methyl-1,3,5-triazin-2-yl)carbamoyl]benzenesulfonamide and also the compounds Nos. I-1, I-2, I-3, I-4, I-12, I-18, I-19 from Table 1 have very good herbicidal activity against harmful plants such as Amaranthus retroflexus, Lolium multiflorum, Abuthilon theophrasti, Matricaria inodora, Ipomoea purpurea, Stellaria media, Veronica persica and Viola tricolor when applied by the post-emergence method at an application rate of 0.1 kg or less of active substance per hectare.

### 3. Compatibility with Crop Plants

In further tests in the greenhouse, seeds of a relatively large number of crop plants and weeds were placed in sandy loam and covered with soil. Some of the pots were immediately treated as described in section 1, the others were placed in the greenhouse until the plants had developed two to three true leaves and were then sprayed with 2-iodo-N-[(4-methoxy-6-methyl-1,3,5-triazin-2-yl)carbamoyl]benzenesulfonamide and also, for example, the compounds Nos. I-1, I-2, I-3, I-4, I-12, I-18 and 1-19 from Table 1, as described in section 2. Four to five weeks after the application and residence in the greenhouse, it was found by visual scoring that the compounds tested did not damage barley at all or left only marginal traces of damage even at relatively high application rates.

### 4. Replanting Behavior

In further tests, various dosages of the test substances were worked into the soil. Subsequently, various crop plants were sown in plastic pots filled with the treated soil and cultivated in a greenhouse using a day/night rhythm of 22° C./14° C. After four weeks, the plants were scored according to the scheme below.

0%=no damage
100=complete damage

Tables B1-1 to B1-5 contain the results of tests with sugar beet using different application rates of (a) the compound I-2 according to the invention and (b) metsulfuron-methyl.

TABLE B1-1

| | Amount of active | Sugar beet |
|---|---|---|
| | compound | damage |
| Compound | g of ai/ha | in % |
| I-2 | 30 | 92 |
| metsulfuron- | 30 | 94 |
| methyl | | |

TABLE B1-2

| | Amount of active | Sugar beet |
|---|---|---|
| | compound | damage |
| Compound | g of ai/ha | in % |
| I-2 | 7.5 | 85 |
| metsulfuron- | 7.5 | 90 |
| methyl | | |

TABLE B1-3

| | Amount of active | Sugar beet |
|---|---|---|
| | compound | damage |
| Compound | g of ai/ha | in % |
| I-2 | 1.9 | 61 |
| metsulfuron- | 1.9 | 85 |
| methyl | | |

TABLE B1-4

| | Amount of active | Sugar beet |
|---|---|---|
| | compound | damage |
| Compound | g of ai/ha | in % |
| I-2 | 0.5 | 1 |
| metsulfuron- | 0.5 | 18 |
| methyl | | |

TABLE B1-5

| | Amount of active | Sugar beet |
|---|---|---|
| | compound | damage |
| Compound | g of ai/ha | in % |
| I-2 | 0.1 | 0 |
| metsulfuron- | 0.1 | 11 |
| methyl | | |

Tables B2-1 to B2-5 contain the results of tests with oilseed rape (Brassica napus) using different application rates of (a) the compound I-2 according to the invention and (b) metsulfuron-methyl.

TABLE B2-1

| | | Brassica |
|---|---|---|
| | Amount of active | napus |
| | compound | damage |
| Compound | g of ai/ha | in % |
| I-2 | 30 | 94 |
| metsulfuron- | 30 | 96 |
| methyl | | |

TABLE B2-2

| | | Brassica |
|---|---|---|
| | Amount of active | napus |
| | compound | damage |
| Compound | g of ai/ha | in % |
| I-2 | 7.5 | 83 |
| metsulfuron- | 7.5 | 86 |
| methyl | | |

TABLE B2-3

| | | Brassica |
|---|---|---|
| | Amount of active | napus |
| | compound | damage |
| Compound | g of ai/ha | in % |
| I-2 | 1.9 | 29 |
| metsulfuron- | 1.9 | 54 |
| methyl | | |

TABLE B2-4

| | | Brassica |
|---|---|---|
| | Amount of active | napus |
| | compound | damage |
| Compound | g of ai/ha | in % |
| I-2 | 0.5 | 1 |
| metsulfuron- | 0.5 | 11 |
| methyl | | |

TABLE B2-5

| | | Brassica |
|---|---|---|
| | Amount of active | napus |
| | compound | damage |
| Compound | g of ai/ha | in % |
| I-2 | 0.1 | 0 |
| metsulfuron- | 0.1 | 5 |
| methyl | | |

Tables B3-1 to B3-5 contain the results of tests with broad beans (Vicia faba) using different application rates of (a) the compound I-2 according to the invention and (b) metsulfuron-methyl.

TABLE B3-1

| | Amount of active | Vicia faba |
|---|---|---|
| | compound | damage |
| Compound | g of ai/ha | in % |
| I-2 | 30 | 93 |
| metsulfuron- | 30 | 99 |
| methyl | | |

TABLE B3-2

| | Amount of active | Vicia faba |
|---|---|---|
| | compound | damage |
| Compound | g of ai/ha | in % |
| I-2 | 7.5 | 49 |
| metsulfuron- | 7.5 | 96 |
| methyl | | |

TABLE B3-3

| | Amount of active | Vicia faba |
|---|---|---|
| | compound | damage |
| Compound | g of ai/ha | in % |
| I-2 | 1.9 | 2.5 |
| metsulfuron- | 1.9 | 43 |
| methyl | | |

TABLE B3-4

| | Amount of active | Vicia faba |
|---|---|---|
| | compound | damage |
| Compound | g of ai/ha | in % |
| I-2 | 0.5 | 2.5 |
| metsulfuron- | 0.5 | 8 |
| methyl | | |

TABLE B3-5

| | Amount of active | Vicia faba |
|---|---|---|
| | compound | damage |
| Compound | g of ai/ha | in % |
| I-2 | 0.1 | 2.5 |
| metsulfuron- | 0.1 | 5 |
| methyl | | |

1. A method for selective control of unwanted vegetation comprising using 2-iodo-N-[(4-methoxy-6-methyl-1,3,5-triazin-2-yl)carbamoyl]benzenesulfonamide and/or a salt thereof for the selective control of unwanted vegetation (a) by the pre-emergence method (PE) in crop plants optionally comprising wheat, corn, soybeans, sugar beet, sugar cane, rice, cotton, beans, peas, flax, barley, oats, rye, triticale, potatoes and millet and also (b) by the post-emergence method (PO) in crop plants optionally comprising barley, oats, rye, triticale, potatoes, broad beans, flax, pasture land and greens/lawns, where the crops mentioned above in each case include summer and winter varieties and also cultivars modified by genetic engineering or by mutagenesis, and (c) on non-crop land and in plantation crops.

2. A method as claimed in claim 1, wherein the salt of 2-iodo-N-[(4-methoxy-6-methyl-1,3,5-triazin-2-yl)carbamoyl]benzenesulfonamide used comprises a compound of formula (I) 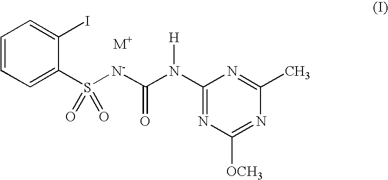
where
the cation (M⁺) (a) is an alkali metal ion, or
(b) is an alkaline earth metal ion, or
(c) is a transition metal ion, or
(d) is an ammonium ion in which optionally one, two, three or all four hydrogen atoms are substituted by identical or different radicals from the group consisting of (C₁-C₄)-alkyl, hydroxy-(C₁-C₄)-alkyl, (C₃-C₆)-cycloalkyl, (C₁-C₄)-alkoxy-(C₁-C₄)-alkyl, hydroxy-(C₁-C₄)-alkoxy-(C₁-C₄)-alkyl, (C₁-C₆)-mercaptoalkyl, phenyl and benzyl, where the radicals mentioned above are optionally substituted by one or more identical or different radicals from the group consisting of halogen, nitro, cyano, azido, —NCO, —NCS, (C₁-C₆)-alkyl, (C₁-C₆)-haloalkyl, (C₃-C₆)-cycloalkyl, (C₁-C₆)-alkoxy, (C₁-C₆)-haloalkoxy and phenyl, and where in each case two substituents at the nitrogen atom together optionally form an unsubstituted or substituted ring, or
(e) is a phosphonium ion, or
(f) is a sulfonium ion, or
(g) is an oxonium ion, or
(h) is a saturated or unsaturated/aromatic nitrogenous heterocyclic ionic compound which has 1-10 carbon atoms in the ring system and is optionally mono- or polycondensed and/or mono- or polysubstituted by (C₁-C₄)-alkyl.

3. A method as claimed in claim 1, wherein 2-iodo-N-[(4-methoxy-6-methyl-1,3,5-triazin-2-yl)carbamoyl]benzenesulfonamide and/or a salt thereof is applied at an application rate of from 0.01 to 1000 g of a.i./ha.

4. A method as claimed in claim 1, wherein 2-iodo-N-[(4-methoxy-6-methyl-1,3,5-triazin-2-yl)carbamoyl]benzenesulfonamide and/or a salt thereof is applied to an emerged harmful plant.

5. A method for the selective control of unwanted vegetation in barley, wherein 2-iodo-N-[(4-methoxy-6-methyl-1,3,5-triazin-2-yl)carbamoyl]benzenesulfonamide and/or a salt thereof as defined in claim 1 is applied to a plant, seed and/or an area in which plants grow.

6. The method as claimed in claim 5, wherein 2-iodo-N-[(4-methoxy-6-methyl-1,3,5-triazin-2-yl)carbamoyl]benzenesulfonamide and/or a salt thereof is applied at an application rate of from 0.01 to 1000 g of a.i./ha.

7. The method as claimed in claim 5, wherein the unwanted plant comprises broad-leaved weeds/weed grasses and/or unwanted crop plants.

8. The method as claimed in of claim 5, wherein 2-iodo-N-[(4-methoxy-6-methyl-1,3,5-triazin-2-yl)carbamoyl]benzenesulfonamide or a salt thereof is applied to an emerged harmful plant.
